(19) United States
(12) Patent Application Publication
(10) Pub. No.: US 2013/0164718 A1
(43) Pub. Date: Jun. 27, 2013

(54) HANDHELD DIABETES MANAGER WHICH SUPPORTS PREPLANNED MEALS FOR IMPROVED THERAPY

(71) Applicant: Roche Diagnostics Operations, Inc., Indianapolis, IN (US)

(72) Inventors: Schuyler S. Buck, Muncie, IN (US); Kristin M. Westerfield, Indianapolis, IN (US)

(73) Assignee: ROCHE DIAGNOSTICS OPERATIONS, INC., Indianapolis, IN (US)

(21) Appl. No.: 13/692,569

(22) Filed: Dec. 3, 2012

Related U.S. Application Data
(60) Provisional application No. 61/580,330, filed on Dec. 27, 2011.

(51) Int. Cl. G09B 19/00

(52) U.S. Cl. CPC G09B 19/0092
USPC 434/127

(57) ABSTRACT

A handheld diabetes management device is provided which supports preselected meals for improved therapy. The diabetes management device includes: a food database that stores nutritional information for a plurality of food items; a meal selection module that enables a user to preplan meals for a diabetic patient using the food database; and a meal planner module that facilitates use of the preplanned meals to improve therapy for the patient. The diabetes management device further includes an insulin management module that forecasts amounts of insulin needed by a patient over a period of time.

### CROSS-REFERENCE TO RELATED APPLICATIONS

This application claims the benefit of U.S. Provisional Application No. 61/580,330, filed on Dec. 27, 2011. The entire disclosure of the above application is incorporated herein by reference.

### FIELD

The present disclosure relates to diabetes management and more particularly to diabetes management devices configured to support preplanned meals to improve therapy in diabetes management.

### BACKGROUND

Diabetes mellitus, often referred to as diabetes, is a chronic condition in which a person has elevated blood glucose levels that result from defects in the body's ability to produce and/or use insulin. There are three main types of diabetes. Type 1 diabetes usually strikes children and young adults, and can be autoimmune, genetic, and/or environmental. Type 2 diabetes accounts for 90-95% of diabetes cases and is linked to genetic predisposition, obesity and/or physical inactivity. Gestational diabetes is a form of diabetes diagnosed during pregnancy and usually resolves spontaneously after delivery. Without treatment, diabetes can lead to severe complications such as heart disease, stroke, blindness, kidney failure, amputations, and death related to pneumonia and flu.

Management of diabetes is complex because the level of blood glucose entering the bloodstream is dynamic. Variation of insulin in the bloodstream that controls the transport of glucose out of the bloodstream also complicates diabetes management. Blood glucose levels are sensitive to diet and exercise, but also can be affected by sleep, stress, smoking, travel, illness, menses, and other psychological and lifestyle factors that are unique to each patient. The dynamic nature of blood glucose and insulin, and all other factors affecting blood glucose, often require a person with diabetes to forecast blood glucose levels based on these factors. Accordingly, appropriate management of diabetes involves large amounts of diagnostic data and prescriptive data that are acquired from medical devices, personal health care devices, patient recorded information, health care professional tests results, prescribed medications and recorded information. Oftentimes, the amount of information necessary to provide adequate care can be overwhelming to a patient. Automation of the number of inputs that a patient must provide enables the patient to improve his or her care and health, to lead a full life, and to reduce the risk of complications from diabetes.

Insulin is often used as part of the therapy regimen for people with diabetes, and is always necessary for those with type 1 diabetes. Administration of insulin and/or oral medications should be regulated and timed to maintain these blood glucose levels within an appropriate range at all times. Insulin can be administered with a syringe, an insulin pen, an ambulatory infusion pump, or a combination of two or more of the above. With insulin therapy, determining the amount of insulin to inject and the type of bolus at a given time can require consideration of the effects of meals, exercise, physiologic state, etc. Therefore, it is desirable that a diabetes management device enable a patient or a patient's caregiver to preplan for meals that are to be consumed by the patient. When planning meals for a patient, the caregiver may also desire to know the amount of insulin that the patient would need over a given period of time in view of the meal selections. Moreover, the diabetes management device should accommodate changes to meals planned for the patient. In some instance, it may be advisable for caregivers to be notified of any changes to the preplanned meals. Such tools are not readily available to diabetic patients and their caregivers.

The background description provided herein is for the purpose of generally presenting the context of the disclosure. Work of the presently named inventors, to the extent it is described in this background section, as well as aspects of the description that cannot otherwise qualify as prior art at the time of filing, are neither expressly nor impliedly admitted as prior art against the present disclosure.

### SUMMARY

A handheld diabetes management device is presented which supports preplanned meals for improved therapy. The diabetes management device includes: a food database that stores nutritional information for a plurality of food items; a meal selection module that enables a user to preplan meals for a diabetic patient using the food database; and a meal planner module that facilitates use of the preplanned meals to improve therapy for the patient.

The meal selection module presents one or more food items from the food database for selection by a user and stores the user's food selections in a data store as a preplanned meal, wherein the preplanned meal includes one or more food items selected for consumption by a patient, an indicator of quantity for each of the selected food items and a time at which the patient expects to consume the selected food items. The meal selection module further operates to create a reminder event for the preplanned meal in a calendar application, where the reminder event correlates to the time at which the patient expects to consume the selected food items.

The meal planner module is configured to receive a reminder in response to the reminder event and prompt the user to confirm the food selections. Upon receiving confirmation of food selections, the meal planner module further operates to send a notification to a caregiver for the patient.

The diabetes management device may further include an insulin management module that forecasts amounts of insulin needed by a patient over a period of time. The insulin management module can compare the forecasted quantity of insulin to an amount of available insulin and present the forecasted quantity of insulin to the patient or caregiver, for example when the forecasted quantity of insulin exceeds the amount of available insulin. The insulin management module is further operable to send a notification to a caregiver, the notification advising the caregiver of the forecasted quantity of insulin.

Further areas of applicability will become apparent from the description provided herein. The description and specific examples in this summary are intended for purposes of illustration only and are not intended to limit the scope of the present disclosure.

### DRAWINGS

The present disclosure will become more fully understood from the detailed description and the accompanying drawings, wherein:

FIG. 1 is a diagram illustrating an example embodiment of a handheld diabetes management device in accordance with the present disclosure;

FIG. 2 is a high level block diagram of various components and subsystems that may be incorporated in the device shown in FIG. 1;

FIG. 3 is a block diagram of an exemplary software arrangement for the diabetes management device which supports preplanning of meals

FIG. 4 is a diagram of an exemplary menu for navigating the food database; and

FIG. 5 is a flowchart depicting an exemplary embodiment of the insulin management module.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

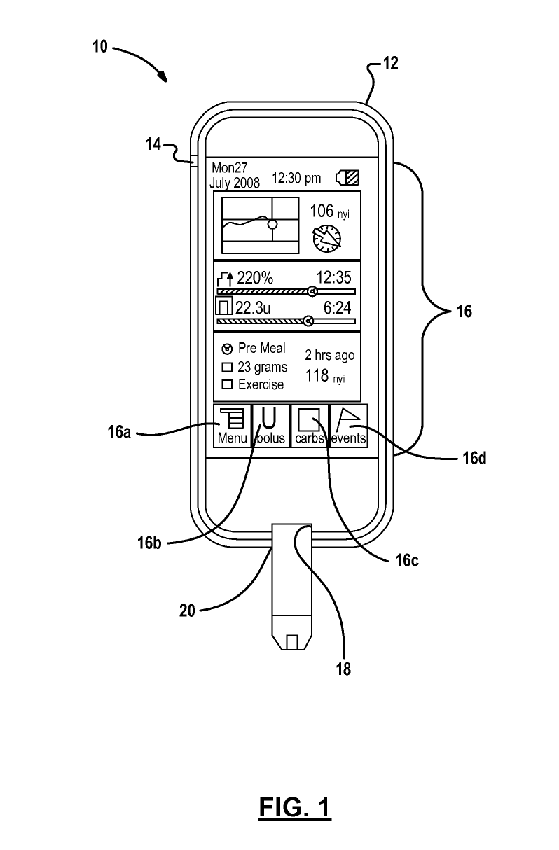

FIG. 1 depicts an exemplary embodiment of a handheld, diabetes management device 10 that may be used in measuring the blood glucose (bG) of a patient and implementing a bolus calculation or carbohydrate suggestion. The device 10 includes a housing 12 that may contain user unit control switches 14 (e.g., ON/OFF), a touchscreen display 16, and a port 18 into which a bG test strip 20 may be inserted. The display 16 may display user selectable options for allowing the user to access a software driven menu 16a of various selections, a selection 16b for allowing the user to enter bolus information, a selection 16c for enabling the user to enter carbohydrate information for snacks or meals, and a selection 16d for allowing the user to enter information pertaining to health events (e.g., meals, exercise, periods of stress, periodic physiological events such as a menstrual cycle, etc.) that may affect the user's bG measurement being read by the device 10. Although the display 16 will be described herein as a touchscreen input, it will be appreciated that any other suitable form of input for the display may be incorporated (e.g., buttons, mouse, etc.). If a touchscreen display is not used, the user control switches 14 may need to include specific buttons or controls by which the user is able to select various options and input markers needed to carry out the bolus calculation or carbohydrate suggestion. It will be appreciated that the above is a high level description of the device 10, and in practice the device may include additional controls, input ports, output ports, etc., as may be desired to further enhance the utility of the device 10 or its use with other components and devices (e.g., laptop computers, infusion pumps, etc.). Accordingly, the above description of the device 10 should not be taken as limiting its construction or features in any way.

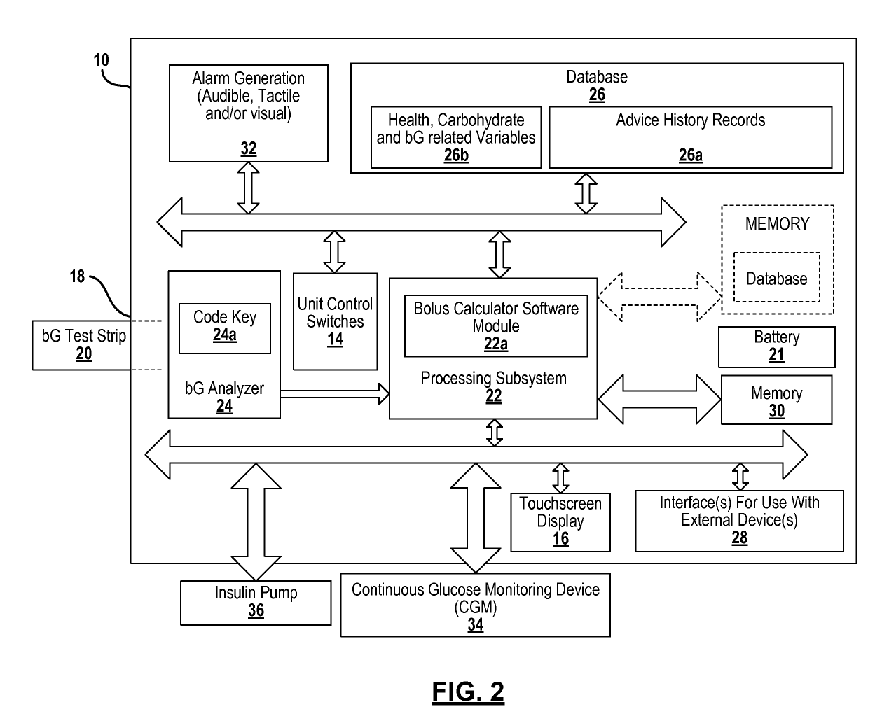

FIG. 2 further depicts an exemplary construct for the diabetes management device 10. The device 10 can include a rechargeable or non-rechargeable battery 21 for powering the various electronic components of the device 10. A processing subsystem 22 (e.g., a microprocessor based subsystem) is included that receives information from a bG analyzer 24 (also referred to herein as a blood glucose measurement module). The bG analyzer 24 is located adjacent the port 18 of the housing 12 to permit the bG analyzer 24 to read the bG test strip 20. The bG analyzer 24 can include a code key 24a that includes calibration information for the bG test strip 20 being read. The processing subsystem 22 can also be in communication with a database 26 that is used to store bG test values obtained from the bG analyzer 24 and other important health related information for the user. In particular, the database 26 can include a subsection 26a for storing recommended bolus and carbohydrate advice history records (hereinafter “advice history records”) that are still active in their influence of current and future advice, and a section 26b for storing medication (insulin), health, carbohydrate and bG related variables (e.g., insulin sensitivities of the user for various time segments of the day) pertinent to the user. It will be appreciated that the database 26 will be formed by a non-volatile memory. Further, the related variables such as the insulin sensitivities of the user can be stored as global parameters and may not be in the advice history records.

The processing subsystem 22 can also be in communication with the display 16, the user control switches 14, and one or more interfaces 28 for interfacing the device 10 to other external devices. The processing subsystem 22 can also be in communication with a memory (such as a RAM) 30 for storing various types of information (e.g., meal and bed times) that are input by the user, as well as any other information requiring temporary or permanent storage. However, it will be appreciated that the database 26 and the memory 30 could be implemented in a single memory device (e.g., RAM) if desired, as indicated in phantom in FIG. 2. The processing subsystem 22 can be in communication with an alarm generation subsystem 32 that is used to generate an alarm consisting of audible signals, tactile signals (e.g., a vibration signal) or possibly even visual signals such as illuminated lights (e.g., LEDs) on the device 10. The processing subsystem 22 can also receive inputs from a remote continuous glucose monitoring (“CGM”) device 34 secured to the user's body such that device 10 is continually updated with glucose information for the user. Finally the processing subsystem 22 can be in communication with a remote insulin infusion pump 36 (herein referred to as an “insulin pump 36”) being worn by the user so that the device 10 is able to communicate bolus information to the insulin pump 36. By “remote” it is meant that the CGM device 34 and the insulin pump 36 are each located outside of the device 10 but otherwise still in communication with the device 10. It should be appreciated that the device 10 can communicate with the insulin pump 36 either through a wired or wireless connection.

The device 10 can be used to implement a non-transitory machine readable code, for example a bolus calculator software module 22a (herein referred to as “bolus calculator 22a”), that is run by the processing subsystem 22. The bolus calculator 22a can be formed as a single module or as a collection of independent modules that run concurrently on the processing subsystem 22. The processing subsystem 22, working in connection with the bolus calculator 22a, receives a wide variety of user inputs applied by the user through the touchscreen display 16 to generate a recommended correction bolus, a recommended meal bolus, a recommended total bolus, or when appropriate a suggested carbohydrate amount. The suggested carbohydrate amount may be provided in response to the detection by the device 10 of a hypoglycemic bG test value. The operations and capabilities of the device 10 will be explained in detail in the following paragraphs. The device 10 significantly enhances the convenience and ease of use to the user through the implementation of a plurality of customizable inputs that enable the user to program the device 10 with unique health information pertinent to the user. More specifically, the device 10 allows the user to program the device 10 with health information which even more completely enables the device 10 to take into account unique health conditions affecting the user, as well as regular occurring and non-regular occurring health events that could otherwise have an impact on the bolus and carbohydrate calculations made by the device 10.

In an example embodiment, the bolus calculator 22a is configured to generate advice history records which are indicative of the bolus and carbohydrate calculations and bolus recommendations made by the device 10. The bolus calculator 22a may be further configured to include data indicative of a patient's adherence or variance from the recommendations in the advice history records. In some embodiments, an advice history record can include a plurality of fields, including a time field that defines a time of the advice history record, a test flag field, a record content field indicating one or more types of events defined in the advice history record, and one or more fields defining values corresponding to the events indicated in the record content field. It should be appreciated that the advice history record may include variations of the fields described above or alternative or additional fields. The fields of the advice history record provided are provided for example only and not intended to be limiting. Further details regarding an exemplary bolus calculator may be found, for example in U.S. patent application Ser. No. 13/593,557 entitled “Handheld Diabetes Management Device with Bolus Calculator” which is incorporated by reference herein.

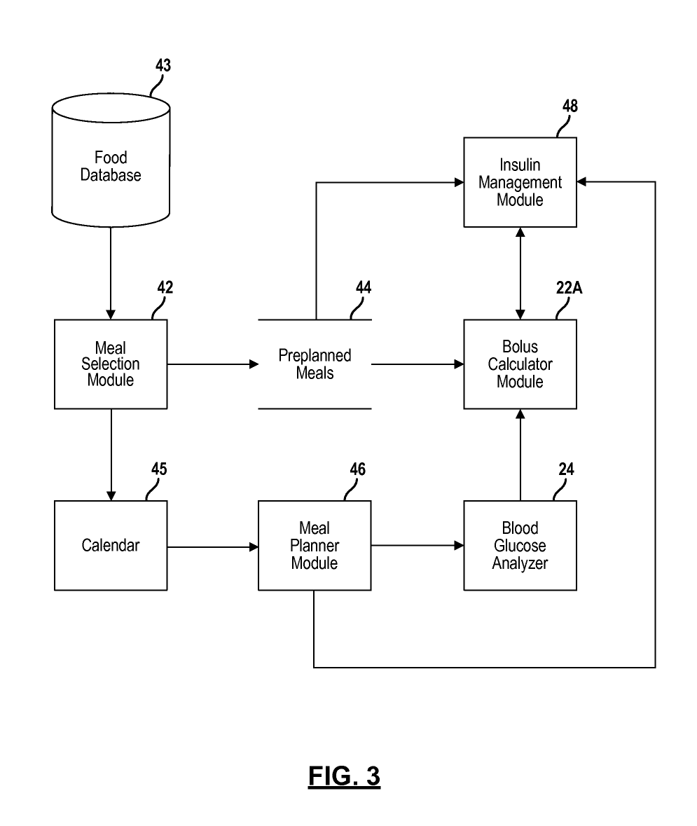

FIG. 3 depicts an exemplary software arrangement for a diabetes management device 10 which supports preselection of meals, for example by a caregiver for improved therapy. In addition to bolus calculator 22a, the diabetes management device 10 may further include a meal selection module 42, a meal planner module 46 and an insulin management module 48. In one exemplary embodiment, each software module is implemented as non-transitory machine readable code that is run by the processing subsystem 22. It is also envisioned that each module may be implemented as part of or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip.

The meal selection module 42 enables a user to preplan meals for a diabetic patient. To do so, the meal selection module 42 is in data communication with a food database 43. The food database 43 stores nutritional information for a plurality of food items. Food items may include a meal selection (e.g., menu item from a franchise restaurant) or an individual food item (e.g., an item commonly found in a grocery store). The food database 43 may include a predefined number of food items as well as a predefined number of meals with each meal comprised of one or more food items. Alternatively or additionally, the food items in the food database 43 may vary over time. For example, food items may be added or modified locally by a user of the diabetes management device 10. In another example, updates to the food items may be downloaded from a source remote from the diabetes management device 10. Each food item in the food database 43 may have an associated icon indicating where it originated (e.g., approved source, manually added by user, downloaded from internet, etc.). For example, foods added by the caregiver may be shown in an alternate color or with a particular icon alongside the food item on the screen. In this way, comfort with the accuracy of the nutritional parameters for various foods may be maintained.

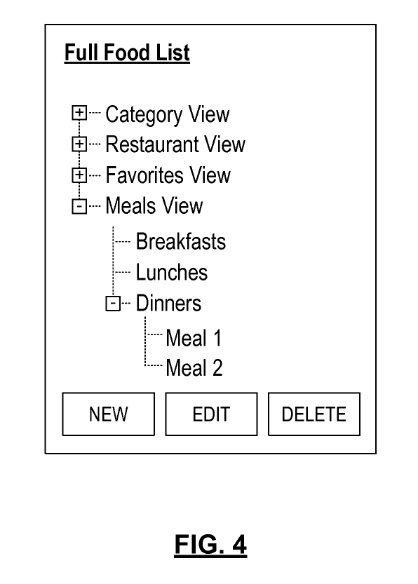

During operation, the meal selection module 42 interacts with the food database 43 to present one or more food items for selection by the user. In an exemplary embodiment, the food items are presented for selection on a display of the diabetes management device 10. The food items may be presented, for example as shown in FIG. 4. Food items may be grouped into different views. For example, food items may be grouped by category (i.e., fruits, vegetables, etc.), by restaurant, by meals or by favorites. Each grouping may or may not include sub-groupings of food items. Each food item can have nutritional information associated therewith. Nutritional information may include but is not limited to calories, total fat, total percentage of calories from fat, saturated fat, trans fat, cholesterol, sodium, total carbohydrates, dietary fiber, sugar, protein, vitamin A, vitamin C, calcium, and iron. Nutritional information for selected food items can subsequently be used by the bolus calculator 22a when formulating a bolus recommendation.

By navigating the menu structure, a user may select a predefined meal and/or individual food items which are to be consumed by a patient during a particular meal, thereby specifying a preplanned meal. Each preplanned meal will include one or more food items selected from the food database 43, along with an indicator of the quantity to be consumed for each selected food item. The quantity may have a default value and/or be specified by the user upon selection of a given food item. Each preplanned meal may also include a time at which the patient expects to consume the selected food items. In the exemplary embodiment, the preplanned meals are stored in a data store 44 residing on the diabetes management device 14.

A health care provider or caregiver for the patient may tailor the food database 43 to the needs of the patient using the meal selection module 42. Specifically, the caregiver may add or remove food items from the food database 43. For example, the caregiver may remove foods items that will never be eaten by the patient from the full food list (e.g., due to an allergy). In another example, the caregiver may designate select food items to the favorite foods list. The caregiver may also designate a favorite breakfast meal for patient (e.g., oatmeal). In these ways, the patient or caregiver are able to quickly and easily personalize items in the food database 43.

Operation of the diabetes management device 10 may be further understood in relation to an example use case. Julia is a mother with a son, Max, who has recently been diagnosed with Type 1 diabetes. Julia uses the enhanced functionality of the diabetes management device 10 to improve therapy for Max. For example, Julia is getting Max ready for school, and makes his breakfast. She decides to make fried eggs. She picks up Max's diabetes management device 10, inserts a test strip and tests his bG, and clicks a button to get bolus advice. She goes to the carb entry field and selects the food list option. She has previously set up the device to show Max's favorites by default. She finds fried egg in his favorites, notes that there are no carbs in a fried egg and confirms the default serving of 1 large egg. She decides to search for another food item, and switches to the category view. She scrolls to the Fruit category, and finds strawberries listed alphabetically in this category. She sees that the default serving size is 1 cup. She adds the strawberries. Next, she returns to find the rest of the meal. She sees that she can sort the list alphabetically or by nutritional parameter. She can also find her most recently used items, which she thinks will be very helpful since Max likes orange juice with every meal. She adds a cup of orange juice and a slice of toast and sees the total carbohydrates of the meal.

Julia sees that there is an option to save this meal for future use. She decides to save this meal and calls it “fried egg breakfast”. She confirms this, and is taken back to the bolus calculation screen. The carb, fat, fiber and protein fields of the bolus calculator have been filled in as 60 g, 11 g, 13 g, and 13 g, respectively, for this meal. Based on the nutritional information, the bolus calculator suggests a standard bolus. Based upon her conversation with Max's physician about Max's normal response to meals like fried eggs, she decides to make it an extended bolus instead. She selects to deliver the bolus and serves Max his breakfast.

The meal selection module 42 is also configured to create a reminder event for the preplanned meal. The reminder event correlates to the time at which the patient expects to consume the selected food items. For instance, the reminder event specifies a time before the designed meal time (e.g., 5-30 minutes) at which to initiate a reminder. In one exemplary embodiment, the meal selection module 42 may interface with a calendar application 45 (e.g., Microsoft Outlook manager application) to log a reminder event. In another exemplary embodiment, the meal selection module 42 may implement the applicable calendar functions itself.

The meal planner module 46 facilitates use of the preplanned meals to improve therapy for the patient. For example, the meal planner module 46 prompts the patient, in response to the reminder, to confirm the food selections, including quantities, associated with a preplanned meal. For example, the meal planner module 46 may prompt the patient by displaying the food items along with designated quantities on a display of the diabetes management device 10. The visual prompt may be accompanied by an audible alarm, tactile feedback (e.g., vibration), or a combination thereof. Should circumstances dictate a change in the meal, the patient may elect to change the food items to be consumed and/or quantity of the food items being consumed during the meal. Once the patient confirms the food selections, the meal planner module 46 can send a notification to a caregiver advising the caregiver of patient's confirmation, where the notification is sent electronically via a data link to a network address (i.e., phone number or email address) or a device associated with the caregiver. Rather than sending a notification each time food selections are confirmed by the patient, the meal planner module 46 may send a notification only when the patient makes changes of the preplanned meal. In this way, the caregiver is advised on any modifications to the preplanned meal. Any changes to a preplanned meal are also updated in the data store 44.

Upon receiving confirmation of the food selections, the meal planner module 46 prompts the patient to take a blood glucose measurement. The patient can in turn interact with the blood glucose analyzer 24 to take a blood glucose measurement. The blood glucose measurement is stored in the database 26 as noted above.

In view of the confirmed food selections, the meal planner module 46 may also initiate a bolus recommendation by the bolus calculator 22a. The bolus calculator 22a is configured to receive the current blood glucose measurement from the blood glucose analyzer 24 and retrieve the confirmed food selections from the data store. The bolus calculator 22a can then determine a recommended amount of insulin (i.e., bolus) to be administered in connection with the upcoming meal. In most instances, the meal planner module 46 will preferably require a bolus recommendation before recommending and/or administering insulin to the patient. In some instances, the meal planner module 46 may forego a bolus recommendation, for example if the food selections remain unchanged and the patient's current blood glucose measure corresponds to an expected glucose measure for the patient.

With continued reference to the example use case, Julia wants to set up the meals Max will eat for the next week. She sits down with him on Saturday afternoon to go through the cafeteria menu at his school to decide what foods he will eat. She opens the preselected foods option, and adds Max's breakfast options first from meals she has previously created for him. For each breakfast, she adds a time of 7:30, and sets the appropriate day of the week. Next, she adds the items they have selected for his lunch and adjusts the portion sizes and times. She also sets up an option to make sure the meter will remind Max of what he is supposed to eat 15 minutes before it is time to eat.

Julia saves the preselected meals to the meter, and emails a copy of the selections to Max's healthcare provider and school nurse. Because Max has only recently been diagnosed with diabetes, both his healthcare provider and school nurse are trying to help Julia understand carb counting and how to make Max's therapy better.

Max heads to school. At 11:00, his meter buzzes. He checked it, and it asks is he having fruit and chicken for lunch. He hasn't left to go to the cafeteria from his classroom yet, so he delays the reminder by 5 minutes. The reminder appears again, and he confirms his lunch choices. In the event Max alters the preplanned meal, an email notification is sent by the diabetes management device to an address or device associated with Julia. In any case, Max is asked to take a bG test, and then taken to the bolus calculation screen, where the carb value has already been entered. He confirms the bolus and diabetes management device 10 sends a command to the insulin pump to deliver insulin. Julia loves the sense of control this gives her over Max's therapy while she isn't with him, including the ability to preplan meals.

On Tuesday night, Max's meter buzzes to confirm his meal selection. Julia's day has not gone as planned. Instead of having the lasagna dinner she had planned to prepare, she has been dealing with repairmen at her house. Unfortunately, tonight, dinner will be at a restaurant. She picks up Max's meter, and indicates that Max will not be eating lasagna. Instead, she goes to the meals view of the food database. Because it is dinnertime, the meals at the top of the list are those she has set up as primarily dinner meals for Max. She selects a meal, and makes a quick adjustment to the portion sizes she had previously selected. She is asked if she would like to update the meal for future use to these values. She decides to leave the settings for the meal as it is—she only wants to change the meal for tonight. She confirms the meal choice, and is prompted to test Max's bG. She tests his bG, and then selects to receive bolus advice.

With continued reference to FIG. 3, the insulin management module 48 helps a caregiver to manage the insulin needed by a patient during a predefined time period, such as throughout a given day or over the course of a few days. For example, the insulin management module 48 can forecast a quantity of insulin needed over a predefined period of time, for example based upon preplanned meals retrieved from the data store 44. The insulin management module 48 may also operate to present the forecasted quantity of insulin on a display of the diabetes management device 10.

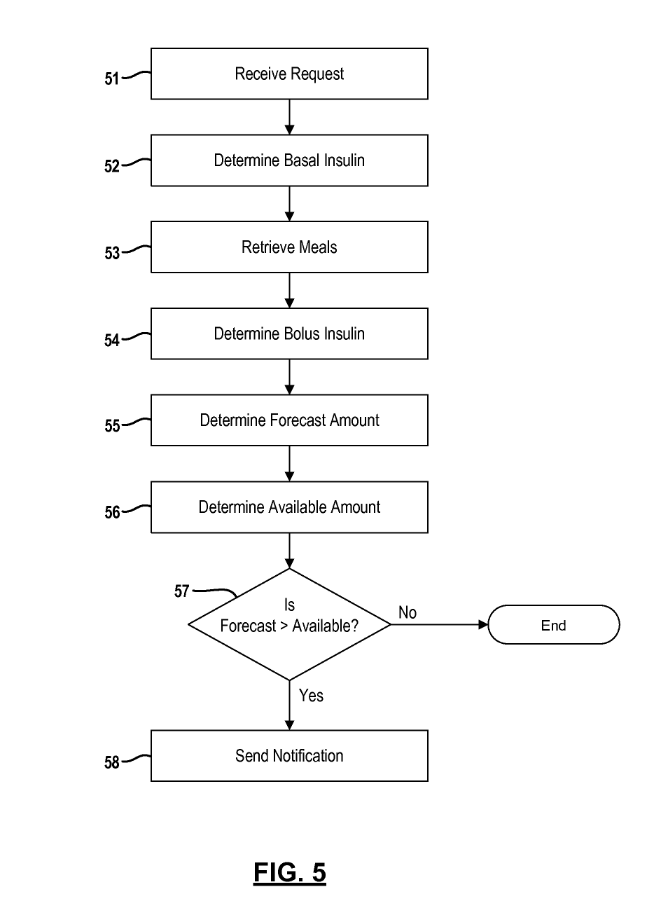

An exemplary embodiment of the insulin management module 48 is further described in relation to FIG. 5. Insulin usage may be forecasted in response to a request from the user of the diabetes management device 10 as indicated at 51. The request will specify the period of time for which to forecast insulin usage. The period of time may be set by a user or default to a given value, such as a single day.

In an exemplary embodiment, the forecasted quantity of insulin may include basal insulin as well as bolus insulin. Basal insulin is a type of slow acting insulin prescribed to control blood sugar through the day. Basal insulin may be administered to the patient one or more times a day. Given a period of time for which to forecast, the insulin management module 48 can determine the amount of basal insulin needed for the time period. The prescribed quantity of basal insulin for a given day may be stored locally and accessible to the insulin management module 48.

On the other hand, bolus insulin is a type of fast acting insulin that gives the body a quick rise in insulin levels to deal with elevated blood glucose levels commonly caused, for example, by meals. To forecast bolus insulin usage, the insulin management module retrieves at 53 each of the preplanned meals which are to occur during the time period. For each meal, the insulin management module 48 interacts with the bolus calculator 22a at 54 to determine a recommended amount of bolus insulin for a given meal. Historical data for the patient may be used to provide a blood glucose measure anticipated at the meal time to the bolus calculator 22a. The insulin management module 48 can in turn sum the quantities of bolus insulin needed over the course of the specified time period at 55, thereby yielding the forecasted quantity of insulin for the time period.

Given a forecasted quantity of insulin, the insulin management module 48 may further operate to present the forecasted quantity of insulin to the caregiver or user of the device. In one exemplary embodiment, the insulin management module 48 merely displayed the forecasted quantity of insulin on a display of the diabetes management device 10. In another exemplary embodiment, the insulin management module 48 determines at 56 the amount of insulin available for use by the patient. The amount of available insulin may be a parameter input and maintained by the caregiver on the diabetes management device 14. The amount of available insulin may also be retrieved by the insulin management module 48 from an insulin pump in data communication with the diabetes management device 14. The forecasted quantity of insulin is then compared at 57 to the amount of available insulin. In this case, the forecasted quantity of insulin and/or a difference between the forecasted amount and the available amount of insulin is presented, for example, when the forecasted quantity exceeds the amount of available insulin. In this way, the caregiver and/or patient can monitor the amount of available insulin and replenish the insulin as needed by the patient.

In some embodiments, the insulin management module sends a notification to the caregiver and/or the patient's healthcare provider advising them as to the forecasted quantity of insulin and/or the difference between the forecasted amount and the available amount of insulin. The notification may be sent only when the forecasted quantity exceeds the amount of available insulin. The notification is sent electronically via a data link to a network address (i.e., phone number or email address) or a device associated with the caregiver. The insulin management module 48 interfaces with a suitable messaging application, such as an email or text messaging, to send the appropriate notification to the caregiver.

The insulin management module 48 is also configured to receive the confirmation of food selections from the meal planner module 46. When the confirmation indicates a change in either the food items to be consumed or the quantity of the food items to be consumed, the insulin management module 48 can recalculate the forecasted amount of insulin needed by the patient. A notification advising the caregiver of a change in the forecasted quantity of insulin can be initiated by the insulin management module 48. In one embodiment, the notification may be sent only when the forecasted quantity of insulin exceeds the amount of available insulin.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description is merely illustrative in nature and is in no way intended to limit the disclosure, its application, or uses. For example, although the diabetic patient 10, the health care professional 12, or the caregiver may have been described as performing a particular step, it should be understood that the requisite actions may be performed by any of the healthcare professional 12, the caregiver, or the diabetic patient 10 themselves.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A handheld diabetes management device which supports preplanned meals for improved therapy, comprising:
a food database that stores nutritional information for a plurality of food items;
a meal selection module in data communication with the food database and operable to present one or more food items from the food database for selection by a user, the meal selection module configured to receive selections of food items from the user and operable to store the food selections in a data store as a preplanned meal, wherein the preplanned meal includes one or more food items selected for consumption by a patient, an indicator of quantity for each of the selected food items and a time at which the patient expects to consume the selected food items;
the meal selection module further operates to create a reminder event for the preplanned meal in a calendar application, where the reminder event correlates to the time at which the patient expects to consume the selected food items;
a meal planner module is configured to receive a reminder from the calendar application in response to the reminder event and operable to prompt the user to confirm the food selections;
a glucose measurement module configured to receive the confirmation of the food selections from the user and operable, in response to the confirmation of food selections, to prompt the user to take a blood glucose measure;
a bolus calculator configured to receive a blood glucose measure from the glucose measurement module and operable to determine a recommended amount of insulin for the preplanned meal based in part on the blood glucose measure and the food selections; and
an insulin management module configured to receive the food selections from the data store and operable to forecast a quantity of insulin needed over a predefined time period based in part on the food selections and to present the forecasted quantity of insulin.

2. The handheld diabetes management device of claim 1 wherein the meal planner module is configured to receive the confirmation of the food selections, where the confirmation of the food selections includes a change in at least one of the food items selected and the indicator of quantity, and operates to send a notification to a caregiver, the notification advising the caregiver of the change in at least one of the food items selected and the indicator of quantity.

3. The handheld diabetes management device of claim 1 wherein the nutritional information include a carbohydrate count for each of the food items, and the bolus calculator determines the recommended amount of insulin using the carbohydrate count for the selected food items.

4. The handheld diabetes management device of claim 1 wherein the meal selection module receives further selections of food items for consumption by the patient at a second time and stores the food selections as a second preplanned meal, and the insulin management module is operable to forecast a quantity of insulin needed over the predefined time period which includes the preplanned meal and the second preplanned meal.

5. The handheld diabetes management device of claim 1 wherein the insulin management module compares the forecasted quantity of insulin to an amount of available insulin and presents the forecasted quantity of insulin only when the forecasted quantity of insulin exceeds the amount of available insulin.

6. The handheld diabetes management device of claim 1 wherein the insulin management module is configured to receive the confirmation of the food selections, and operates to recalculate the quantity of insulin needed when the confirmation of the food selections includes a change in at least one of the food items selected and the indicator of quantity.

7. The handheld diabetes management device of claim 1 wherein the insulin management module is further operable to send a notification to a caregiver, the notification advising the caregiver of the forecasted quantity of insulin.

8. A computer-implemented method for preplanning meals for a patient using a handheld diabetes management device, comprising:
receiving, by a diabetes management device, selections of food items for a preplanned meal;
creating, by the diabetes management device, a reminder event for the preplanned meal, the reminder event occurring at a time at which the patient expects to consume the preplanned meal;
prompting, by the diabetes management device, the patient to confirm food selections of the preplanned meal in response to the reminder event;
receiving, by the diabetes management device, confirmation of food selection from the patient; and
sending, by the diabetes management device, a notification to a caregiver upon detecting a change in at least one of the food selections, where the notification is sent electronically via a data link to a device associated with the caregiver.

9. The method of claim 8 further comprises prompting, by the diabetes management device, the patient to take a blood glucose measure in response to receiving confirmation of food selections from the patient.

10. The method of claim 8 further comprises forecasting, by the diabetes management device, a quantity of insulin needed over a period of time based the food selections of the preplanned meal.

11. The method of claim 10 further comprises comparing the forecasted quantity of insulin to an amount of available insulin and presenting the forecasted quantity of insulin only when the forecasted quantity of insulin exceeds the amount of the available insulin.

12. The method of claim 10 further comprises forecasting a quantity of insulin needed over a period of time upon detecting a change in at least one of the food selections of the preplanned meal.

13. The method of claim 10 further comprises sending a notification to the caregiver advising the caregiver of the forecasted quantity of insulin.

14. A handheld diabetes management device which supports preplanned meals for improved therapy, comprising:
a food database that stores nutritional information for a plurality of food items;
a meal selection module in data communication with the food database and operable to present one or more food items from the food database for selection by a user, the meal selection module configured to receive selections of food items from the user and operable to store the food selections as a preplanned meal in a data store, wherein the preplanned meal includes one or more food items selected for consumption by a patient, an indicator of quantity for each of the selected food items and a time at which the patient expects to consume the selected food items;
the meal selection module further operates to create a reminder event for the preplanned meal in a calendar application, where the reminder event correlates to the time at which the patient expects to consume the selected food items;
a meal planner module is configured to receive a reminder from the calendar application in response to the reminder event and operable to prompt the user to confirm the food selections;
the meal planner module further operates to send a notification to a caregiver upon receiving confirmation of the food selection, where the notification advises the caregiver as to the confirmation of the food selections and is sent electronically via a data link to a device associated with the caregiver;
a glucose measurement module configured to receive the confirmation of the food selections from the patient and operable, in response to the confirmation of food selections, to prompt the patient to take a blood glucose measure;
a bolus calculator configured to receive a blood glucose measure from the glucose measurement module and operable to determine a recommended amount of insulin for the preplanned meal based in part on the blood glucose measure and the food selections; and
an insulin management module operates to forecast a quantity of insulin needed over a predefined time period based in part on the food selections retrieved from the data store and present the forecasted quantity of insulin on a display of the device.

15. The handheld diabetes management device of claim 14 wherein the meal selection module receives further selections of food items for consumption by the patient at a second time and stores the food selections as a second preplanned meal, and the insulin management module is operable to forecast a quantity of insulin needed over the predefined time period which includes the preplanned meal and the second preplanned meal.

16. The handheld diabetes management device of claim 14 wherein the insulin management module compares the forecasted quantity of insulin to an amount of available insulin and presents the forecasted quantity of insulin only when the forecasted quantity of insulin exceeds the amount of available insulin.

17. The handheld diabetes management device of claim 14 wherein the insulin management module is configured to receive the confirmation of the food selections, and operates to recalculate the quantity of insulin needed when the confirmation of the food selections includes a change in at least one of the food items selected and the indicator of quantity.

18. The handheld diabetes management device of claim 14 wherein the insulin management module is further operable to send a notification to a caregiver, the notification advising the caregiver of the forecasted quantity of insulin.
